(19) United States
(12) Patent Application Publication
(10) Pub. No.: US 2006/0026147 A1
(43) Pub. Date: Feb. 2, 2006

(54) Adaptive search engine

(76) Inventors: Julian Malcolm Cone, Christchurch (NZ); Gary Lee Franklin, Christchurch (NZ); Grant James Ryan, Christchurch (NZ); William Ferguson Stalker, Christchurch (NZ)

Correspondence Address: Stephen M. De Klerk;BLAKELY, SOKOLOFF, TAYLOR & ZAFMAN LLP, Seventh Floor, 12400 Wilshire Boulevard, Los Angeles, CA, 90025, US

(21) Appl. No.: 11/195,225

(22) Filed: Aug. 2, 2005

(30) Foreign Application Priority Data
Jul. 30, 2004 (NZ) 534459

(51) Int. Cl. G06F 17/30

(52) U.S. Cl. 707/3

(57) ABSTRACT

An adaptive search engine (1) having a plurality of data items (4) from one or more data sources (5) stored in at least one database searchable by a search query (6) of a least one keyword (7) to produce a corresponding ranked search result listing (8) of data items (4), said search engine having a plurality of selectable filters (9) applicable by the search engine and/or the user to filter at least a portion (10) of the data items (4) of the search result listing (8), characterised in that said search engine records an association between a filter (9) applied to a search query (6) and a data item (4) selected by a user from said filtered portion (10) of the corresponding search result listing (8), wherein each recorded association contributes to the weighting given by the search engine (1) to application of said filter (9) in a subsequent search for at least one keyword (7) of said search query (6).

### CROSS-REFERENCE TO RELATED APPLICATIONS

The present patent application claims priority from New Zealand Patent Application No. 534459, filed on Jul. 30, 2004.

### TECHNICAL FIELD

The present invention relates to an adaptive search engine capable of enhancing the relevance of search results by learning from user interaction with at least partly filtered search results.

### BACKGROUND ART

The prolific expansion and utilisation of the internet has made internet search engines an indispensable feature of many users” internet usage. Numerous techniques are known for search engines to enquire, catalogue and prioritise websites according to predetermined categories and/or according to the particular search query. Numerous methods of enhancing the quality of the search results provided by search engines according to particular search queries are known, including those disclosed in the applicant's earlier patents U.S. Pat. No. 6,421,675, U.S. Ser. No. 09/155,802, U.S. Ser. No. 10/213,017, NZ518624, PCT/NZ02/00199, and NZ528385, incorporated herein by reference.

Conventional search engines filter and prioritise the search results providing a ranked listing based on: a) Keyword frequency and meta tags; b) Professional editors manually evaluating sites/directories; c) How much advertisers are prepared to pay, and d) Measuring which websites webmasters think are important implemented by link analysis, which gives more weighting to sites dependent on what other sites are linked to them.

U.S. Pat. Nos. 6,421,675, U.S. Ser. No. 10/155,914, and U.S. Ser. No. 10/213,017 disclose a means of refining searches according to the behaviour of previous users performing the same search. These patents harness the discriminatory powers of the user to effectively provide a further filtering and screening of search results to the subsequent behaviour when presented with search results listings. If a particular website is deemed to be of greater relevance, the user will typically access the website for some duration and/or perform other activities denoting a relevant website, such as clicking on embedded links therein, downloading attachments, and the like. By preferentially weighting websites according to the user's behaviour in relationship to a particular search query, the search engine is able to enhance the relevance of the search result listings.

While this removes the website from its sole dependency of the above criteria a)-d) for its ranking, it is still driven by the influence of the whole web populous, whose interests and tastes may differ greatly from a given individual user.

PCT/NZ02/00199 discloses a personal contact network system whereby a user may form a network of contacts known either directly or indirectly to the user. The network may be used for a variety of applications and takes advantage of the innate human trait to give a higher weighting to the opinions of those entities with whom a common positive bond is shared, such as friendship. NZ pat app No. 528385 and PCT/NZ2004/000228 developed this technique by providing a means of influencing the ranking or weighting of search results according to the preferences of entities (individuals, groups or organisations) deemed of more relevance or importance to the user.

Despite the above developments, internet searching still presents the typical user with a multitude of results, only a small portion of which are relevant or even accessed by the user. The volume of results may be reduced and the relevance increased by use of one or more filters. Although not always provided by search engines, such filters range from geographical/domain name restrictions (e.g. New Zealand websites only), newsgroups, blogs (web logs), directories, Boolean operators, file formats, images, mature content filters, and the like. Despite the availability of such filters, these must still be applied manually by the user and are thus ignored by typical users, averse to such overt and proactive searching actions. This results in infrequent and inefficient filter usage by typical users and by the search engines.

All references, including any patents or patent applications cited in this specification, are hereby incorporated by reference. No admission is made that any reference constitutes prior art. The discussion of the references states what their authors assert, and the applicants reserve the right to challenge the accuracy and pertinency of the cited documents. It will be clearly understood that, although a number of prior art publications are referred to herein, this reference does not constitute an admission that any of these documents form part of the common general knowledge in the art, in New Zealand or in any other country.

It is acknowledged that the term “comprise” may, under varying jurisdictions, be attributed with either an exclusive or an inclusive meaning. For the purpose of this specification, and unless otherwise noted, the term “comprise” shall have an inclusive meaning—i.e. that it will be taken to mean an inclusion of not only the listed components it directly references, but also other non-specified components or elements. This rationale will also be used when the term “comprised” or “comprising” is used in relation to one or more steps in a method or process.

It is an object of the present invention to address the foregoing problems or at least to provide the public with a useful choice.

Further aspects and advantages of the present invention will become apparent from the ensuing description which is given by way of example only.

### DISCLOSURE OF INVENTION

According to one aspect, the present invention provides an adaptive search engine having a plurality of data items from one or more data sources stored in at least one database searchable by a search query of a least one keyword to produce a corresponding ranked search result listing of data items, said search engine having a plurality of selectable filters applicable by the search engine and/or the user to filter at least a portion of the data items of the search result listing,

characterised in that

said search engine records an association between a filter applied to a search query and a data item selected by a user from said filtered portion of the corresponding search result listing, wherein each recorded association contributes to the weighting given by the search engine to application of said filter in a subsequent search for at least one keyword of said search query.

Preferably, said filters include, but are not limited to: one or more said data sources; Keyword filters; user submissions—including user comments, answers to questions, chat-room threads, blog inputs and the like, news, picture); search groups; human editorial control/moderator; user-behaviour analysis; Keyword suggestions; Website filter; Domain filters; Link analysis filters; Category filters; Class of query (ranked according to whether or not the search query had been performed previously and if so, on search success); Advanced rule-based learning adaptations of other filters; Data item creation or update date; User's geographic location; Language; File format, frequency of spidering web-pages; and/or Mature Content filter.

Although the present invention is applicable on any suitable network including local and wide area networks (LAN and WAN respectively), intranets, mobile phone services, text messaging, and the like, it is particularly suited to the internet and the invention is described henceforth with respect to same. It will be appreciated this is exemplary only, and the invention is not limited to internet applications. Consequently, although the term “data items” encompasses not only websites and web pages but also any discrete searchable information item such as images, downloadable files, specific texts, or any other electronically classifiable and/or searchable data, reference is made henceforth to data items as internet web pages.

As discussed above, a conventional search engine typically provides a ranked search result listing based on a) keyword frequency and meta tags; b) manual evaluation of website by professional editors; c) advertising fees, and d) link analysis. Improvements over these methods are afforded by the technology employed in the earlier patents U.S. Ser. No. 09/115,802, U.S. Ser. No. 10/155,914, U.S. Ser. No. 10/213,017, NZ518624, NZ528385, and PCT/NZ2004/000228 to increase (and/or optionally decrease) the ranking of a selected data item over unselected data items in the search results listing.

The present invention preferentially (though not essentially) utilises the above technologies. Preferably, therefore, said search engine classifies a selection of a data item as being relevant when the user performs at least one action in association with the selected data item to meet at least one predetermined relevancy criteria.

Similarly, according to one aspect, the search engine reduces the ranking of a selected data item when the user does not perform at least one action in association with the selected data item to meet at least one predetermined relevancy criteria, said selected data item being classified as irrelevant.

Thus, said predetermined relevancy criteria includes, but is not limited to, whether the user accesses a data item for longer than a predetermined period (a lengthy access period implying the item was of interest), accessing further data items directly from the first selected data item, submitting and/or downloading data to/from the data item. An irrelevant data item may be classified as the failure of the user to perform any of these actions. The relevancy criteria may be varied according to the specific characteristics of the search, e.g. search queries relating to sporting results, or fixture dates characterised by brief access times, in contrast to scientific or engineering queries where users would spend longer on a relevant website.

In a typical search, prior art search engines either incorporate no feedback from the subsequent user selections from the search results listings, or (as discussed above) obtain feedback on the usefulness of the selected result directly from the users actively to re-rank subsequent results listings for the same search query.

The present invention is able to further improve the relevancy of the search results listings (irrespective of how the search results listing are initially obtained) by “learning” from recording the effect on the user's behaviour of any filters applied. Considering an example where the user inputs a search query with the keyword “job vacancies,”an unrestricted search would produce a plethora of search results. The search engine may for example also apply the keyword filter “New Zealand”for users with a New Zealand IP address and mix the resultant links with the standard results in the listings provided to the user. By recording which links the user accesses (particularly “relevant” links as discussed above), the relevance of the filter (i.e. the tem “New Zealand”) can be determined by the proportion of users accessing the filtered portion of the results. The association between user-selections of results from the filtered portion causes the search engine to affect the weighting given to the application of the filter. This weighting may be adjusted in numerous ways, e.g. if the majority of users accessed results including the “New Zealand” keyword, the search engine could increase the portion of the search results subjected to the filter. Equally, if it was found the filtered portion received no additional attention from the user, the filtered portion of the results may be decreased or even eliminated. Alternatively, alterations in the weighting given by the search engine to the filter may relate to altering the ranked position of the filtered results within the search listings.

It can be seen from the above inexhaustive list of filters that numerous means of “weighting” are possible. Considering the use of different data sources as filters, the system may mix results from say, a specific data source such as a specialised external vertical search engine or a specific website together with the general results. Any preferential selection of the results associated with the data source will lead to an increased weighting to the future application of that filter/data source, e.g. increasing the number and/or ranking of the results present in the results listing obtained from that site and vice versa.

Thus, according to one embodiment of the present invention, an increase or decrease in said weighting of the application of a filter includes a commensurate increase or decrease in:
the proportional volume of said filtered portion results;
the ranking of the filtered portion results;
the number and/or ranking of results obtained from a given data source.

The term “data sources” as used herein includes, but is not limited to websites, domain names and categories, personal contact networks, news groups, search groups, third party search engines including category-specific search engines, geographical regions, blog sites, intranets, LAN and WAN networks, and/or any other form of searchable source of data.

The search engine may also include one or more data sources in the search results listings itself—e.g. a search query with the keyword “angling” may generate a search result option (or generate a suggestion) to re-run the search with the results from the “Fishing” search group or from a fishing-orientated search engine. If the user selects such an option, the subsequent search is performed with an increased weighting of that filter, i.e. the inherent characteristics of the particular search group or search engine. It can thus be seen that the present invention is customisable to interface with numerous external data sources to distil the relevant search results listing without the need for the present invention search engine to acquire all the data items.

Search groups form a potentially powerful and flexible search feature, particularly in conjunction with the present invention. In its basic form, a search group is a category-specific group which shares its search results and preferred data sources, essentially they are groups of users with similar views of what is relevant. Thus, while the members of the “Fishing” search group for example would pool search results on all matters pertaining to fishing, the same members may also be members of other search groups and are thus not obliged to have a fishing bias on any non-fishing searches they want to perform.

The searches within a search group may be considered as self-regulating, in that the users will naturally perform searches and/or choose results influenced by, or targeted towards the stated aim or ethos of the group and consequently will also choose searches with appropriate or relevant keywords. Thus, the searches by a particular search group may not necessarily be directed towards the actual category or theme of the search group, and in fact may be related to any category or subject whatsoever. Nevertheless, the relevant selected data items from the search results will reflect the context of the search group. The user selections from resulting search listings will be re-ranked according to the relevancy or irrelevancy of the result according to the techniques previously discussed. Thus when a user performs a search query for keywords already searched by other group members, the result listings generated will already display combined effects of all the previous re-ranking performed for the same keywords by the other search group members. It may optionally also display one or more “suggestions” listings compiled from searches or sites obtained from the direct or indirect recommendations of the group members, said suggestions listings including:
recent searches denoting the most recent keywords or search result listings associated with the keywords used by the user contacts;
popular websites denoting a ranking of websites most regularly visited by, and/or recommended by the user contacts;
popular searches denoting a ranking of the most popular keywords or search results associated with the keywords used by the user contacts;
high-flying searches denoting a list of keywords or search result listings associated with the keywords ranked according to their rate of increase in the popular searches ranking;
high-flying websites denoting a list of websites ranked according to their rate of increase in the popular websites ranking.

The above lists correspond to those first described in U.S. patent Ser. No. 09/115,802, NZ Patent No. 507123, and PCT Application No. PCT/US99/05588 incorporated herein. These lists need not be restricted solely to searches within a single search group, but may also be generated for a user performing a search outside a search group and/or drawing results from one or more sources/search groups.

It can be seen, therefore, that the user may indicate a degree of context to their search by using one or more search groups during a search. According to one embodiment, a user may be associated to one or more search groups by:
actively selecting a defined search group;
selecting an external data source from a category-specific third-party search engine or website;
accessing a search box from a category specific website;
selecting from the results listings a link to the same search query performed by a specified search group.

Optionally, a user selecting option c) for a predetermined threshold number of occurrences is automatically made a member of the specified search group. Alternatively, a user selecting a predetermined threshold number results from a search results listing which would have an altered ranking in searches for the same keywords performed by a specified search group is automatically made a member of the specified search group.

Users associated with search groups via any of the above options provide the search engine with context information from which to select relevant filters. When such a user performs a general search query (i.e. without specifying any specific filter), the search engine checks the search query keywords against at least some of the search groups the user is associated with for any re-ranked results, and if so, incorporates them in the general search results listing. If the user happens to be performing a search with no association to the topics of their search group memberships, the unbiased or unfiltered results are still listed for possible selection. Conversely, if the user would have an interest in results with an emphasis on the subjects of their search groups, they will naturally tend towards selecting relevant results from the filtered portion of the search results listings and thus increasing the weighting of the search engine in applying the filter.

It can be thus seen that the search engine will learn over time which filters are effective and which have little beneficial impact, and adapt accordingly. The initial or default choice of filters may be made manually by the user, or by a search group or search engine moderator and/or inferred from settings specified external to the search engine.

A user's search history can be compared with other users to identify similar search patterns. Close matches may be used to add (or suggest being added to the user) search groups common to the parties and/or even create a new search group for the matched users. As it may be inferred the matched users have similar tastes, it creates the possibility for social or business networking by allowing the users to communicate with each other (email, on-line messaging or the like) to discuss their mutual interests.

If a user's pattern of search activity (queries and results) has similarities with those of particular search groups, the user may automatically be added or invited to join the search group.

In a further embodiment, the initial filters applied by the search engine are selected according to one or more context indicators. Thus, according to a further aspect, the present invention provides an adaptive search engine substantially as described above, wherein initial selection of said filter is either user-selected or calculated from one or more predetermined relationships incorporating at least one context indicator related to characteristics of the user, the filter, or both.

As used herein, context indicators include any definable and recordable facet or characteristic of a filter selected by a user and/or a user's interests, contact details, personal or bibliographic details, previous search behaviour, web-surfing behaviour, cookie information, occupation, membership or use of search groups, information shared as part of trusted private personal networks, geographical location, language, domain name type, data voluntarily inputted by the user into the search engine.

There are numerous methods of defining links between a given context indicator and a related filter to be applied in the present invention. As discussed, users can actively input information on their interests directly to the search engine; it can be inferred from their behaviour on websites (e.g. which links are followed, keywords entered, time spent, advertisement links followed) and/or it may be obtained from stored user data as part of a private personal network. This information can be mapped to search groups using a number of known techniques to personalise the user's search. As an example, if a user's personal profile indicated an interest in “Jazz music” and “Band XYZ,”a determination of which search groups are the most frequent users of these keywords may identify the “jazz music” and “Band XYZ Fan group.” Thus, when the user performs a search query for keywords also used by members of either search group, the search engine can include the re-ranked results from the search groups with the general search results listings.

Advanced filtering mechanisms may be employed with data from the users' personal profile information by application of statistical clustering to group users with similar interests. Such techniques enable a calculation of the degree of correspondence between the profiles of users in the statistically identified groups. The resulting matrix of similarities can be used to automatically split the groups into a predefined number of clusters. This information can be used to automatically create new search groups (based on the identified common user interest or the like) which will in turn influence further searches and thus increase the relevance to the user's common interests.

Integration of the present invention with the technology (hereinafter referred to as “personal contacts network”) of patent application Nos. NZ 514368, NZ 518624, and PCT/NZ02/00199 permits context indicators optionally to be obtained directly from the data recorded on each individual. Knowledge that the user has an interest in ornithology, for example, can cause the search engine to introduce search results with keywords associated with the most popular keywords used in the ornithology search group, or for the most popular related keyword to ornithology. The technology associated with the generation of related keywords is well-established, as discussed in U.S. Pat. No. 6,421,675 and patent applications U.S. Ser. No. 09/155,802, U.S. Ser. No. 10/213,017, CA 2,324,137, JP2000/537158, KP2000-7010220, NZ507123, IN2000/00364, AU2003204958 and NZ530061. In the present invention, the keyword suggestion mechanism may also be employed to suggest keyword filters for use by the search engine as initial filters and/or as alternatives to replace filters generating irrelevant or unselected results.

It will be appreciated that even a new user to the search engine will invariably already possess several applied filter data (i.e. such as the user's originating or referring URL, the keywords of the search query they enter, their domain name type and geographical location) which provide at least some context indicators to set up a default search.

Thus, the present invention essentially enhances the quality of the search results by “learning” from the effect on user selections of filters applied by the search engine system or the user. Building on this principle, the search engine may then refine the relevance of the filter for subsequent occurrences of the same search query, providing search listings with an increased application (or “weighting”) of filtered results stemming or “learned” from the user's previous behaviour. In effect, this provides the basis for a contextual weighting to the search leading to more germane results. For example, a search query including the keywords “casting” may raise results related to a) fly-fishing, b) acting or c) foundries, manufacturing, and the like. However, the search engine may indirectly distinguish the context of the search from the user's membership of any search groups associated with the different meanings of the term, e.g. membership of the fishing group could result in the inclusion of additional results with the keyword filter “fishing” in addition to the other “casting” results. User selection of the “casting AND fishing” keywords results would automatically promote results with the context of “casting”intended by the user.

The context indicators relating to the actual context behind the search may thus be at least partially determined by recording information relating to:
the user,
the nature of the search query,
the type of any filters applied to refine the search, and/or
the effects of the filters on the quality of the subsequent results.

The above filters also clearly provide numerous context indicators on which the search engine can base decision-making regarding which filters to employ, suggest, or discard.

Regarding some of the above filters in more detail:

The search results may be obtained from numerous data sources such as internet news feeds, blog sites, advertising, encyclopaedias, specific websites, other search engines, search groups, and so forth. Although the potential list is virtually endless, the same principles apply in that:
a user having an interest in a particular data source may actively filter the results by actively promoting the relative importance of that source on their own search results;
by identifying that the user regularly selects results from a particular data source, the system may automatically increase the weighting given to that data source; and/or
the weighting given to the individual search result selected by the user from a given data source is increased for future searches.

Allowing the user or a search engine/search group moderator a measure of control over the data source(s) contributing to the search results provides a powerful tool for accessing any of thousands of available internet accessible indexes according to criteria defined by the user and or the system. Such sources may be combined by the user in any desired format and provides one means of creating a form of personalised search group structured according to the particular aim of the search.

As discussed above, search groups are category-specific groupings of users agreeing to pool the results of searches performed. The searches need not be specifically in the field of the relevant category of interest. The search group category need not restricted be restricted in any way, and may be any interest, topic, affiliation, activity, issue, or the like of interest to users. The members of an architecture search group, for example, will be interested in the influence of the other members' influence on searches for a wide range of topics, not just architecture. Subsequent searches thus benefit from the focusing brought about by the common interest of the group to improve the relevance of further searches performed in the group category. An individual may create a new search group (with either a public or private membership) focused on a particular interest, and/or use or join existing search groups on an individual search basis or more permanent basis respectively. Private search groups may be formed by invitation only within the user's personal private network (as described in the co-pending patent applications NZ518624 and NZ528385 by the same inventors), while public search groups may be made visible for public access in search engines or even the user's own website.

A search group may specify which filters are used, the rules for their use (including how the weighting applied to a filter is adapted according to user behaviour), and the type of control or “governance” exerted over the search group. Different search groups can choose different information control policies to meet their specific needs and also different methods of allowing the information control policies to be changed. This flexibility is comparable to the different methods used by countries to set policies, i.e., different forms of government. In the present invention, examples of different search group information control policies may include:
Anarchy—each member's behaviour influences the search results and each search group user has moderator rights, i.e., the right to change the information control policies;
Governed Democracy—each member's behaviour influences the search results, but only the search group founder (or authorised successor) has moderator rights;
Autocracy—only the authorised moderator/founder has rights to influence search results or information control policies.

It will be appreciated there are numerous further alternative forms of search group control, e.g. search group members vote to select a moderator, allowing the moderator to designate rights to certain users, only permitting paid or registered (or regular) members to affect search results or promote and demote results and so forth.

Keyword filters such as Boolean operators (e.g. AND, OR, NOT) are well-known filters used to refine search results numbers. The present invention is configurable to enable the automatically incorporation of the most appropriate filters without requiring extensive user input. This recognises that typical users are very reticent in using anything other than the default settings in a search. However, a portion of users do employ available filtering techniques, and these actions also provide direct feedback on the context of the search. For example, an actor performing the search for “casting” may add the Boolean keyword filter “NOT fishing” to eliminate irrelevant angling search results. Users also being members of a private personal network may make portions of their individual data records accessible by the search engine. Thus, the thespian background of the user recorded as a user or “entity” attribute may be used by the search engine as a clear context indicator to filter the search results of ambiguous keywords such as “casting.” Conversely, while the user application of the “NOT fishing” filter also provides a context indicator for the search engine of a user interest in acting, it is not explicit in itself and may also indicate an interest in manufacturing products by casting. Thus, of the two context indicators given in this example, the keyword filter provides a reduced weighting to the search engine to automatically apply the same filter to the same keyword searches performed by other users in comparison to the context indicator of the explicit user attribute information regarding the thespian interest of the user.

Regarding the same search for “casting” performed by a member of a fishing search group or fishing search engine, the system may automatically add the word “fish” to the search query keywords. This may be results from the availability of two context indicators, i.e.; 1) a one-in-three possibility that the intended meaning of “casting” by the user is fishing-related, plus 2) the membership or use of the fishing group search in combination to increase the weighting applied by the search engine to add an explicit fishing-related filter to future “casting” searches by similar users. Irrespective of the means of selecting these initial filters, their relevance will still be determined and continually updated by the ongoing user selections of relevant search results from the filtered portion of the results listings.

Website and domain filters work in a similar manner and may be added to the filtering effects of search groups or any other filters. A search for “Sport X tournaments” in the “Sport X” search group may search the whole internet with “AND Sport X” as a keyword filter and/or restrict the search to certain germane websites, e.g. SportX.com, SportXfans.com. Alternatively, domain filters may be used to restrict or promote results in a search group to websites with a particular top-level domain, e.g. all .gov sites or all .uk sites.

These and any other filters can be applied by the system (including search engine/search group moderators) and/or user to any/all of the search results or combined together in any number of permutations, e.g. different filters can be applied to different queries and it learns which filters achieve the most relevant results for each query. The search engine may, for example, be configured to alternatively combine results from a website filter and keyword filter. Over time, the search engine “learns” which filters are effective from the quality of the search results itself discerned by the activities of the user (with respect to said predetermined relevancy criteria) in preferentially selecting results from the filtered portions of the results listings.

As an example, a breaking news item may result in numerous user queries for the name of a hitherto unknown individual, and consequently the default filters may fail to generate relevant results. The search engine may be configured to automatically switch the data source(s) for its default searches (i.e. the user has not customised the search in any way) from its standard feeds to include news feeds for that particular search query, if the same keyword is being frequently applied to searches in the “News” search groups.

Such adaptive reconfiguring or refining of the search engine filters and data sources associated with a particular search query/keyword(s) may indirectly discern links between keywords and filters that that would otherwise be difficult for an automated expert system approach to anticipate. The search engine may “learn,” for example, that searches prefixed with the keyword “Where” should include a data source filter specifying a “maps search groups/map search engines/map websites” data source.

Thus, in addition to directly determining appropriate filters by the user's selections from the results listings, the search engine system can calculate or “derive” further keywords or websites that could be added to the list of filters. If a particular website featured in a number of search results selected (as relevant) by the user, the data source itself may be added as a possible filter. This “derived” filter may be used, for example, as an automatic data source filter for a search group relevant to the website subject matter, or included as a general search filter for that user.

This principle may be expanded to provide a powerful inferential tool for deriving filters. In any given search, all or a part of the results listings may be analysed to determine any common properties aside from the keywords of the search query.

These common properties may be keywords, data sources, domain names, search group sources, and the like—i.e. the same properties which may be used to filter search results. The potential filter properties associated with the results selected by the user thus provide potential filters for application in subsequent searches. The user selections (whether relevant or irrelevant as hereinbefore defined) from any portion of the results can be used to further refine this list of derived filters extracted from the general search listing. In one embodiment, for example, the search engine may only record derived filters from search results selected by the user. The user behaviour with respect to said predetermined relevancy criteria will not only rank a selected search result as relevant or irrelevant, it will also increase or decrease the weighting the search engine would apply to subsequent application of the filter.

The present invention can thus build a list of important and unimportant data sources for a search group by determining which data sources contribute the search results that are preferentially selected by search group members and which are disproportionately ignored. This analysis may be displayed to the search group members as “important websites,” for example, while data sources yielding infrequently accessed results may be used to compile a “blocked websites” filter to exclude data sources of poor relevance to that particular search group.

Thus, according to a further embodiment of the present invention, a listing of preferred data sources for a search group is complied from data sources contributing search results accessed by the search group users more than a predetermined threshold number of occurrences, and a listing of “irrelevant” data sources for a search group is complied from data sources contributing search results accessed by users less than a predetermined threshold number of occurrences. Preferably, said preferred data sources listing and/or irrelevant data source listing may be displayed to search group users.

Preferably, said irrelevant data sources decrease to the weighting given by the search engine to application of said irrelevant data sources as a derived filter in a subsequent search for the search group. In a further embodiment, said preferred data sources increase the weighting given by the search engine to application of said preferred data sources as a derived filter in a subsequent search for the search group.

In typical applications, the increase or decrease in weighting would be applied directly by the search group moderator. In one embodiment, the list of relevant data sources to a search group for a given search query may be supplemented by data sources providing relevant selections for said given search query performed for other search groups and/or non-search group general searches. Preferably, said supplemented data sources are displayed to the user as suggestions listings, and/or used to contribute at least a proportion of the search result listing to said given search group.

According to a further aspect of the present invention, derived filters may be obtained from any property or characteristic in addition to the search query keywords common to two or more data items in the search results listings. Preferably, said derived filters are obtained from relevant data items selected by the user. Irrelevant data items may be used to demote or eliminate potential derived filters.

Different filters may also be applied not just for different search groups, but also according to different classes of queries and types of searcher, e.g. some never click on suggestions, or search groups.

Different classes of queries may be defined in numerous ways; one method is categorising according to the quality of the search results generated (i.e. good, poor, or previously unseen) with different filters according to the user behaviour within each category, e.g.:

Known Search Queries:

Good results (High proportion of valid clicks, e.g. 70%+):
one main result accessed by majority of users;
numerous good results indicating different user preferences;
numerous good results, though with no pattern;
Good results for some search groups but not others.

Poor results (low proportion of valid clicks—e.g. less than 30%):
No relevant results;
No user selections at all;
Low number of selections.

Uncertain results—any results not falling in any of above categories.

Previously Unseen Search Query:

Short phrase;
Long phrase;
Misspelling.

A change in the type of results obtained for a given search query may be used as a signal to change the filters being applied. As an example, a search query for the keywords “US Open” producing good results when incorporating a data source or keyword filter related to golf may start to produce poor results close to the start of the US tennis open tournament, triggering the search engine to include tennis-related filters.

The default filters for each of these types of queries may be manually set by the search engine webmasters, or by search group moderators or the like. Alternatively, they may be at least partially determined by one or more context indicator(s) associated with the search query, the user, or the results.

The different classifications given above may be used to contribute to the weighting given by the search engine to application of a filter and or configuration changes according to one or more response rules, including:
Keyword suggestions are omitted from the top of search results or shown only at the page bottom for search queries with good results;
Show Keyword suggestions at the top of search results for search queries with poor results;
Show Keyword suggestions at the top of search results for users consistently selecting keyword suggestions;
Only list searches/keywords/websites in the “popular websites/keywords” and/or “high-flying websites/searches” lists that have corresponding good search results;
Change data source if search repeated a predetermined number of times fails to achieve good results;
Use different filters if users access beyond first page of search results to find relevant data item;
Exchange filters if a query is performed twice in a search group with poor results.

Searches for different types of user can also be classified into: frequency of searching activity (high; average; intermittent/occasional); frequency of accessing keyword suggestions, frequency of accessing search groups. These classifications can be used to alter the filters applied and/or the search engine screen configuration accordingly.

The use of filters by the search engine (as opposed to filters deliberately applied by the user) can have a powerful effect on the results, possibly eliminating otherwise good results if applied too widely. As discussed above, this risk may be mitigated by only applying the filter to a portion of the results. A further technique to address this issue is the use of soft filtering, whereby some or all of the results are obtained by a standard search query keyword search or similar, but the ranked listing generated is ranked by one of more filters applied by the search engine. Thus, the user is still presented with the same results, but the adaptive filtering is still able to promote the potentially relevant results. Soft filtering may also be combined with the “hard” filtering techniques discussed above.

In a further embodiment, users can submit to the search engine a web page URL they wish to promote or find of particular importance. This submission may be general to all the users searching or specific to one or more search groups and can be accompanied by keywords and/or a description specified by the user as appropriate for future searches. The search engine may cache the contents of the web page to provide or obtain:
confirmation of the relevance of the keywords and description provided by user;
analysis of additional keywords or topics relevant to the URL;
display preview content of the page when presenting users with details of sites and topics that might be of interest to them, e.g. Newspaper headlines and site reviews;
a backup content copy for instance when the original source is offline or has moved;
a comparison to the current version of the URL to identify if the web page has changed since it was submitted.

As discussed above, users can communicate with other users who have performed searches shown in the recent searches, suggested websites lists, or similar via an email icon next to the appropriate search results or websites. This feature (also incorporated in the earlier referenced patents by the present inventors) may be expanded upon in the present invention, particularly with respect to search groups.

Each search group may be provided with a message board for member discussion on issues. Discussion can be linked to a specific search query or search result, and this forms an ongoing group annotation of the relative merits of different sites. The discussion may also be provided as a link in the search results itself for the relevant search query.

By sharing search results with their personal private network contacts (see earlier referenced patents) and/or members of their search groups, users are effectively sharing bookmarks, as a bookmark is basically a URL that a user has identified as being worth remembering.

URLs explicitly submitted by a general user or search group member may be visually displayed differently to the conventionally derived search result URLs, e.g. as “recommended sites” or “recommended bookmarks” and/or with a corresponding icon.

Submitted bookmarks may be annotated by a user in a directly comparable manner to annotating a website URL from the search results listings, i.e. enable association specific keywords with the bookmarked website. This permits a user to recall a forgotten bookmark by performing a general search for those keywords, which they are more likely to remember.

The ability to submit a website may be added to the user's web browser (via a toolbar or bookmarker) to enable the submission of the site they are currently viewing. The user may control with whom a submitted site is shared, e.g. specific contacts in their personal contacts network, selected search groups, or only viewable exclusively by the user.

Submitted searches may be viewed and searched in a numerous ways, including chronologically, by submitter, by network depth (e.g. search bookmarks for personal contact network friends and friends of friends), by search group category, keyword, and so forth.

A user may also specify whether they were willing to be contacted in relation to a site they have submitted, and by whom, e.g. closeness of contacts from a personal contacts network, search group members, other users possessing the same bookmark.

The user may also be provided with statistics relating to the numbers and type of other users having the same bookmark, and optionally allowing the user to browse the other user's bookmarks.

Bookmarks may be configured to be accessible externally from the search engine (e.g. via an XML feed), and thus be transparently integrated into the user's web browser, supplementing or even replacing conventional bookmarking/favourites systems. Further refinements include a subscription to a particular source of bookmarks (e.g. specific search groups) to notify the user (by email, sms, instant messaging, etc.) of the occurrence of new bookmarks.

Monitoring the usage frequency of a user's submitted bookmarks provides a mechanism for indexing a user's credibility and reputation. This may be indicated as a rating icon associated with the bookmark (with a contact link to communicate with the submitter), or may (in a personal contact network) permit bookmarks from submitters with a high reputation to propagate deeper through their network.

The above-described features of the present invention enable a user to essentially create specialised or “vertical” search engines, particularly by use of the search groups. As the total number of specialised search engines grows, it becomes increasingly possible to combine such specialised search engines to form new composite search engines. For example, a user wishing to create a “New Zealand rugby” search group may combine existing search engines/groups such as a “New Zealand” search group and a “Rugby”search group to provide a nucleus for the new group. The effectiveness of the new “New Zealand rugby” search group may be enhanced by combining results from “New Zealand” search group with the key word filter “Rugby,” and the “Rugby” search group with the keyword filter “New Zealand.” The use of existing search groups/engines as building blocks in the formation of a new search group allows a more rapid establishment of the new group, with less initial members required to produce effective re-rankings of search results.

As well as using existing search groups as a base for a new search group, a user can also “network” search groups so that they share their complied search results and associated results re-rankings. As an example, a search group on “web development” might be linked to the individual “XML”, “HTML”, “CSS”, or “PHP” search groups, so any relevant result identified in any of those groups is shared with the “Web development” search group. Optionally this linkage may be in both directions, so the moderator of the new “web development” search group can offer to share their search activity with the moderators of all the other groups. Conversely, a search group moderator could opt to not make their search group's activity accessible in this manner.

It may be seen that the ability of the present invention to utilise different data sources such as different search groups and search engines may easily be extended to enable the user to utilise any desired data source in the compilation of a search focused on their particular interest. This creates a commercial incentive to produce targeted data sources or indexes to enable users to create such specialised search engines.

Building, maintaining and moderating a search group on a specific subject also provides a commercial opportunity (particularly for niche topics) whereby, a moderator (possibly accessing data source(s) unavailable freely to the general public) could charge a subscription for membership to their search group.

Such commercial models already exist in specialised areas such as law and science, where practitioners are willing to pay for access to a relevant database of specialist information in their field. The present invention means that such database(s) could be just another data source provided to members of the search group. Such a feature provides an attractive path for specialised database proprietors to make their databases more easily accessible via the internet.

“Pop-ups” are a widely despised technique employed to advertise products or services through an automatically opening web window (i.e. a “pop-up”), triggered by a website that you visit, or by a download that you have purposefully, or unsuspectingly, downloaded. Due to the inconvenience and irritation caused by such uninvited intrusions, many users utilise “pop-up blockers.” Despite the poor profile of pop-ups, the reason for their existence remains commercially driven, e.g. advertising

The present invention provides a means of creating a context where pop-ups are expected and potentially welcomed. Instead of unwanted pop-up advertising, the present invention can provide a pop-up search engine. This would have several benefits; firstly, it would lessen the risk of displaying an advertisement that the user is uninterested in. Instead, the search engine is more likely to predict the domain of interest of the current user (through context indicators, the surfing activity of the user during the current session, and the like) and to present the user with an opportunity to do a focused search in that domain. Secondly, by regularly presenting the search engine interface in a repeatable, controlled, and predictable way, the user would be accustomed to its appearance and would not be distracted or irritated by the bizarre animations appearing across the page they are attempting to view typified by conventional pop-ups.

In one embodiment, the specialised search engine may simply appear within an existing toolbar downloaded by the user. Thus, when the user visits a site related to “Sport X,” for example, a link to the search engine is displayed in the toolbar suggesting “Search the Official Sport X website,” or “Search Sport X fan club website.”

It is well-recognised that personal recommendations are a highly influential factor in purchasing products or services. However, to date no automated technologically-supported means have been available for an advertiser to reach their audience online through personal recommendations except by relying on the online equivalent of “word of mouth,” which has several drawbacks. By way of examples:
A user emails a friend to praise a particular product.
   This is equivalent to the users telephoning each other or conversing in person and is a linear information distribution, not exponential. Efficiency gains in using email are only achieved by a user sending a group email. However, a user repeating such behaviour often risks being labelled as a “spammer.”
A user blogs about a product or service on their website.
   This process is equivalent to writing an article in a paper, i.e. it relies on the positive actions of others (readers locating the information and choosing to read it) to propagate the recommendation using their own methods and volition.

The present invention combines two unique technologies—searching and social networking, to allow the creation of “word-of-mouth” online advertising campaigns.

A campaign illustrating this feature may follow a sequence of events including:
Having determined which of their products or services to mount a campaign for (it may be the overall company or a specific product or service, hereafter “the product”), an advertiser produces a website, or a web-page, specific to the “product”;
The advertiser configures the adaptive search engine to create a specialised or “vertical” search engine focused on the product, i.e. “the product” search group, using the above-described features of the invention and those incorporated by reference herein, and then posts the search group to their website;
The advertiser thus has two online promotional sources for their campaign, i.e. new potential customers who use the search engine, and the advertiser's existing customer base (which although often large, are often sealed in large CRM and ERP systems and under-utilised);
The advertiser can thus encourage new users of the search engine to invite their friends/contacts to join “the product” search group. This is facilitated by the search engine through the facility provided for the Advertiser to customise the (above-described) invitation email, including optional links to promotions, discounts, contest entry, rebates, and the like;
The search engine will also assist the advertiser to create customised mass emailing for advertiser's existing clients to appeal to their interests in the advertiser into signing up for “the product” search group;
Any new or existing clients of the advertiser that use “the product” search group and accept cookies will return to the same online experience and user-history when they revisit “the product” search group in the future. The ongoing invitation of other users causes a continued viral and exponential growth;
A proportion of the users of “the product” search group will elect to register with the search engine (or the Advertiser branded version of the search engine). This will create not only additional viral campaign benefit, but will also create the potential for a campaign to be durable as the entire extended network of loyal and supportive users are reachable at any time in the future, and were obtained from individuals who willingly volunteered to hear from the Advertiser). Thus, the advertising expenditure spent on “the product” campaign can pay dividends years later and not just in the current financial year.

In a further embodiment, the search engine may be accessed by a “Search engine Suggester” installed on the user's PC (or similar) by a specialised downloadable desktop application provided by the search engine or an affiliated partner of the search engine. The unobtrusive application runs concurrently while the user is typing in an internet linked document or email. The desktop Search-engine Suggester is thus instantly available to search for any chosen term of interest to the user to find a potential search engine/search group that can be accessed to find focused information. In one embodiment, the user may select any text they have entered on their PC for the Search engine Suggester to present a recommended search engine. Optionally, a single link to a preliminary search result listings based on the text itself may be also be provided to the user.

The Search engine Suggester is configurable to retain information on the preferences of the user. For example, a radiologist having configured the Search engine Suggester with specific preferences, or has a frequent previous user history or has previously joined a radiology search group associated with the adaptive search engine, when the radiologist selects or types the text “compound,”, the Search engine Suggester will combine his preferences and recognition of the keyword to present an appropriate radiology search engine and associated options.

Current search engines do not have the capability to attempt to guess, predict, or offer what the user might want to do following the delivery of the search results listing, other than: “book this trip,” or “buy this product.” In contrast, the present invention is able to provide the user with suggestions of this type. Considering the previous example, a specialist radiologist search engine undertaking a search for the term “compound” may be presented with options and associated mapping for results for Diagnosis, Examples, Treatment, Complications, and/or Case Histories.

It can be thus seen that the present invention provides a means of further enhancing the pertinence of search results, particularly internet searches, by selectively applying filters to search results and learning from any beneficial effect which filters produce the most relevant results.

### BRIEF DESCRIPTION OF DRAWINGS

Further aspects of the present invention will become apparent from the following description which is given by way of example only and with reference to the accompanying drawings in which:

FIG. 1 Shows a schematic representation of a first preferred embodiment of the present invention;

FIG. 2 shows a schematic representation of a portion of the preferred embodiment shown in FIG. 1;

FIG. 3 shows a web page screen according to a preferred embodiment of the present invention;

FIG. 4 shows a further web page screen according to a preferred embodiment of the present invention; and

FIG. 5 shows a further web page screen according to a further preferred embodiment of the present invention.

### BEST MODES FOR CARRYING OUT THE INVENTION

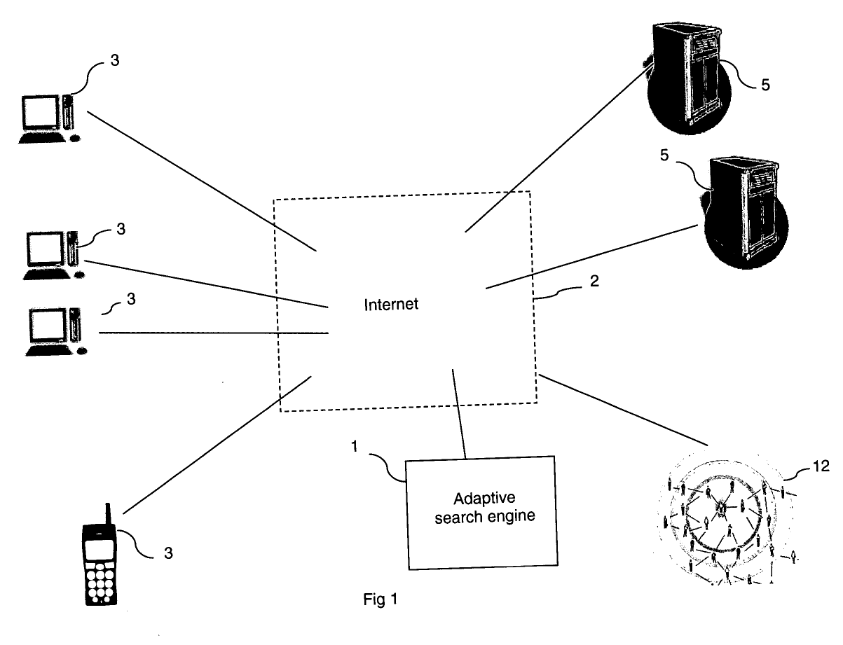

FIGS. 1-5 show preferred aspects of a first embodiment of the present invention of an adaptive search engine (1). Although the present invention may be implemented in any suitable environment with a searchable database on a network, the preferred embodiment (as shown in FIG. 1) is described with respect to use on the internet (2) in which a plurality of users (not shown) may access the search engine (1) through the internet (2) via a plurality of user sites (3) such as personal computers, laptops, mobile phones, PDAs, or the like.

Although known search engines enable searching of the internet (2) for many different forms of data (including websites, web pages, video, audio, files, graphics, databases, encryption, and the like), for the sake of clarity the preferred embodiment is described with respect to searches for data items in the form of websites or website links/URLs (4). It will be appreciated that FIG. 1 is symbolic only and that the internet (2) is actually composed of a multitude of user sites (11) and that searchable data may be obtained from a plurality of data sources (5). Moreover, although the search engine (1) is depicted as a single device, it may be distributed across a network environment including one or more data storage means (not shown), databases, server computers, and/or processors, and although these are not explicitly shown, they are generically represented and encompassed by representation of the search engine (1).

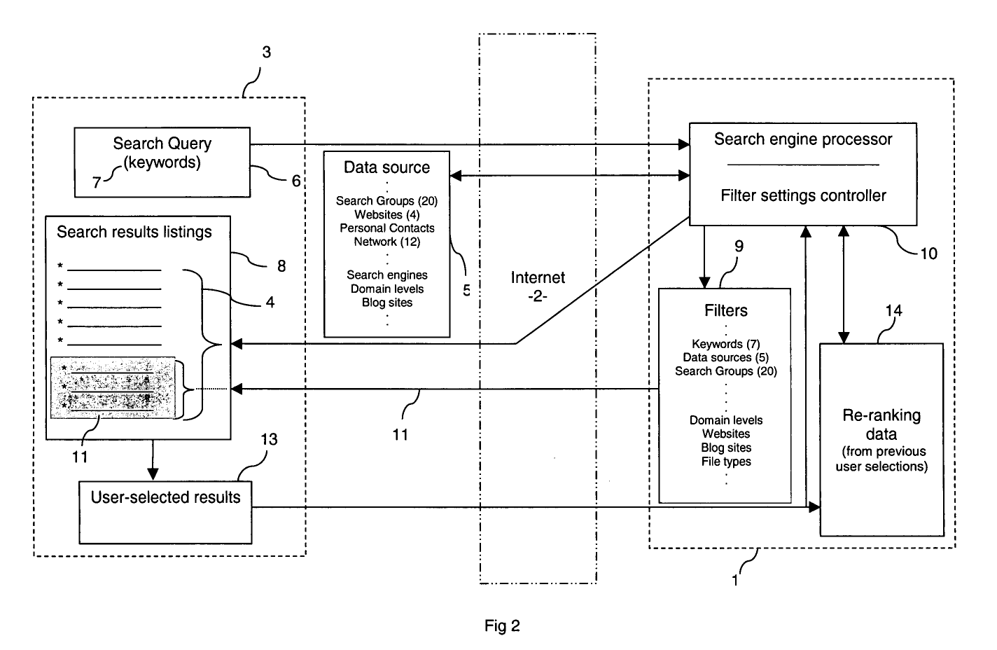

In operation (as shown in FIG. 2), the adaptive search engine (1) is capable of accessing and/or storing a plurality of data items (e.g. internet web page URLs (4)) from one or more data sources (5). The URLs (4) may be stored in at least one database and are searchable by a user-inputted search query (6) of a least one keyword (7) to produce a corresponding ranked search result listing (8) of URLs (4) outputted to the user site (3). The search engine (1) also includes a plurality of selectable filters (9) applicable by a user from a user site (3) and/or by a search engine processor/filter setting controller (10) in the search engine (1) to filter at least a portion (11) of the search result listing (8).

The search engine (1) records an association between a filter (9) applied to a search query (6) and each URL (4) selected by a user from said filtered portion (10) as part of the user results selections (13) from the corresponding search result listing (8). Each recorded association contributes to the weighting given by the search engine (1) to application of the filter (9) in a subsequent search for at least one keyword (7) of the search query (6).

The filters (9) may be of selected from numerous types and sources including one or more said data sources (5); keyword (7) filters; search groups (20); user submissions—including user comments, answers to questions, chat-room threads, blog inputs and the like, news, picture); human editorial control/moderator; user-behaviour analysis; Keyword suggestions; Website filter; Domain filters; Link analysis filters; Category filters; Class of query (ranked according to whether or not the search query had been performed previously and if so, on search success); Advanced rule-based learning adaptations of other filters; Data item creation or update date; User's geographic location; Language; File format, frequency of spidering web-pages; and/or mature content filters.

A data source (5) may be any form of searchable source of data, including websites (4), personal contact networks (12), domain names and categories, news groups, search groups (20), third part search engines including category-specific search engines, geographical regions, blog sites, intranets, LAN and WAN networks and the like.

Although the filters (9) may be selected directly by a user, this is an unlikely in most instances. In the majority of cases, the filters (9) are applied by the search engine filter setting controller (10) as part of a continual monitoring of any URLs (4) in the user results selections (13) selected from the filtered portion (11) from the search results listings (8). There are numerous methods for mixing the filtered portion (11) with the non-filtered URLs (4) in the results listings (8), and the proportional effect of the filter (9) within the whole results listing (8) is controlled by the “weighting” of the filter (9) applied by the filter settings controller (10) to the search results listings (8). Thus, according to one embodiment, an increase or decrease in said weighting of the application of a filter (9) includes a commensurate increase or decrease in:
the proportional volume of said filtered portion (11) results;
the ranking of the filtered portion (11) results;
the number and/or ranking of results obtained from a given data source (5).

In one embodiment, for example, the filtered portion (11) may comprise the total search results listing (8). As this would deny the user an opportunity to select an un-filtered URL (4), it is of limited “learning” value to the search engine (1) if used in isolation. However, by alternating these results with a totally unfiltered search results listing (8) for subsequent occurrences of the same search query (6), comparison data is obtained over time to contribute to the weighting.

In the event that few or no user results selections (13) are obtained from the filtered portions (11), or that a significant proportion are classified as irrelevant, the change in “weighting” of that filter (9) by the filter setting controller (10) may include switching filters completely. If the filter (9) related to a data source (5), e.g. a website relating to a specific topical sports event such as the Tour de France, the change in its relevance for a search query (6) with keywords (7) cycling results may simply signify the event has finished, and a new, more contemporary data source filter (9) is more applicable.

Optionally (though preferably), the user results selections (13) receive re-ranking information (14) according to which URLs (4) comprise the user results selections (13) and the subsequent actions performed by the user accessing the individual URLs (4). Firstly, selected URLs (4) receive an increased ranking over unselected URLs (4) from the search result listings (8). Secondly, the search engine processor (10) classifies a selection of a URL (4) as being relevant when the user performs at least one action in association with the selected URL (4) to meet at least one predetermined relevancy criteria.

Conversely, the ranking of a selected URL (4) is reduced when the user does not perform at least one action meeting at least one predetermined relevancy criteria, said selected URLs thus being classified as irrelevant for the associated search query (6).

The definitions of predetermined relevancy criteria are variable to suit the particular circumstances of the search and any prevailing third-party attempts to distort a URL (4) ranking by illegitimate means. According to one embodiment, the predetermined relevancy criteria include whether the user accesses a URL (4) for longer than a predetermined period (a lengthy access period implying the item was of interest), accessing further URLs (4) directly from the first selected URL (4), and submitting and/or downloading data to/from the URL (4). An irrelevant URL (4) may be classified as the failure of the user to perform any of these actions.

While it can be seen that the ongoing determination of filters (9) is subject to the actions of the search engine (1) users, the initial or default choice of filters may be made in several ways.

One of the main methods is through the user's association with one or more search groups (20), which in its basic form is a category-specific group of users with similar views of what is relevant. Consequently, search group (20) members may share numerous types of information including their search results listings (8), preferred data sources (5), and re-ranking data (14). The user selections (13) from resulting search listings (8) will be re-ranked according to the relevancy or irrelevancy of the result according to the techniques previously discussed. Thus when a user performs a search query (6) for keywords (7) already searched by other group members, the result listings (8) generated will already display the combined effects of all the previous re-ranking performed for the same keywords (7) by the other search group (20) members including the effect of any filters (9) that were applied to yield the selected URL (4).

The initial or default filters (9) associated with some or all search queries (6) within a search group (20) may be specified by the search group creator (as described more fully below), the search group moderator or even the search group members, according to the configuration or “governance” of the search group (20).

A user may be typically associated with one or more search groups (20) by:
actively selecting a defined search group (20);
selecting an external data source (5) from a category-specific third-party search engine or website (4);
accessing a search box from a category specific website (4);
selecting from the results listings (8) a link (4) to a search performed by a specified search group (20) using the same search query (8).

A user selecting option c) for a predetermined threshold number of occurrences may automatically be made a member of the specified search group (20). Alternatively, a user selecting a predetermined threshold number of results (4) from search results listings (8) which would have an altered ranking for searches queries (8) for the same keywords (7) performed by a specified search group (20) is automatically made a member of the specified search group (20).

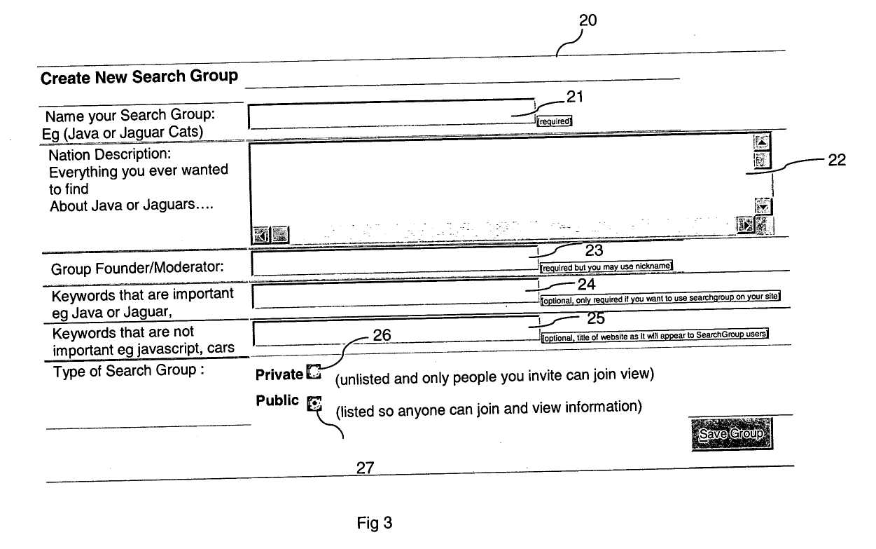

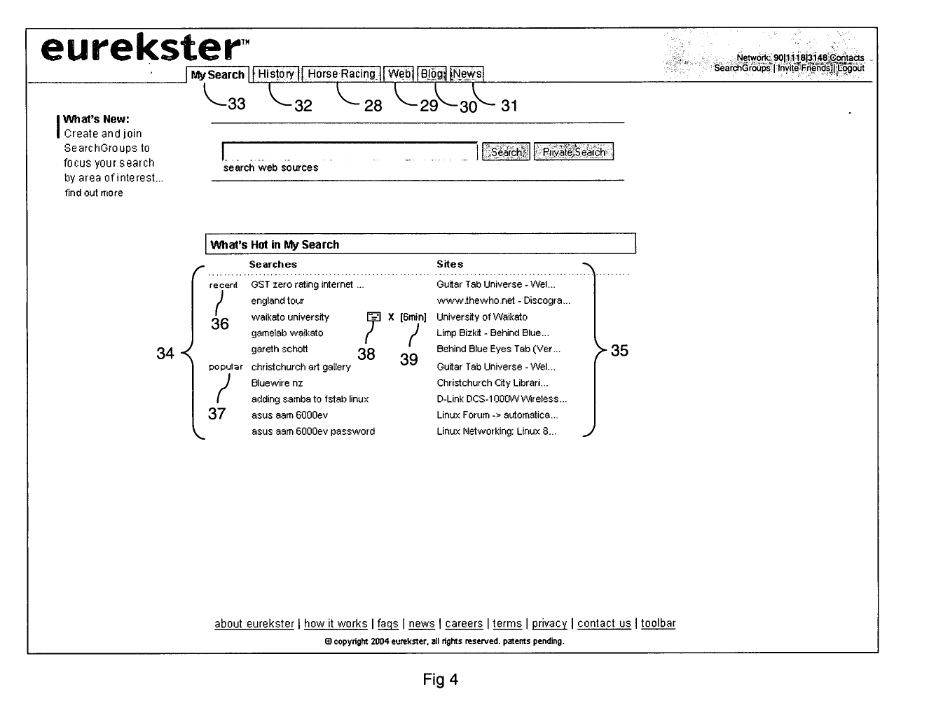

The embodiment shown in FIGS. 3 and 4 shows a means for creating a personalised Search Group (20). FIG. 3 shows the set-up screen presented to a user to form a search group (20) and comprises fields for a:
search group name (21);
description (22) of Search Group type, aim, or ethos (20);
search group (20) founder/moderator (23);
“important” key words (24);
“unimportant” keywords (25), i.e. keywords used to exclude particular results from the search results listings; and
private (26) or public (27) Search Group classifications check boxes.

The “important” keywords (24) provide default filters (9) which can be used to produce a filtered portion (11) to be mixed with the unfiltered “standard” search results URLs (4) in the search results listings (8). The ongoing pertinence of the “important” keywords (24) will be determined according to whether the users consistently select relevant results from the filtered portion (11) of the results incorporating the important keywords (24). Thus, if the user designates particular keywords (7) as “important” keywords (24) which prove to bear little relevance to the actual searching and subsequent selections performed by the users, the relevance of those particular keywords (24) will diminish and the search engine (1) will consequently reduce (or eliminate) the weighting it gives to applying those “important” keywords (24).

Conversely, the unimportant keywords (25) provide the user with an opportunity to input a form of context indicator to the search engine (1) by specifying keywords that are not to be incorporated in the search results listings (8) thus creating a further filtered portion (11), i.e. a portion of the results listing (8) filtered by the exclusion of the unimportant keywords (25). Hence, the user can eliminate irrelevant results generated by the search queries (6) for keywords (7) with multiple meanings, such as “casting.” Thus, by adding the terms “fishing” and “acting” as unimportant keywords (25), the user is effectively specifying context indicators for the Search Group (20).

The user is also given the choice whether to make the Search Group private or public (26, 27). Private Search Groups may be by invitation only, such as through a private personal contact network (12), or by specific email invitation to any third party, and/or by associations with other Search Groups. While this restricts membership to users perceived as having similar interests as that of the Search Group (20), it does restrict the number of searches that may be performed, and thus the ability of the Search Group (20) to re-rank the search results listings (8) accordingly.

Further options (not shown) that may be included in the Search Group (20) set-up include the ability to choose specific data sources (5), (e.g. websites, search engine feeds, blogs, and so forth), languages, exclude certain websites, etc. Further, more advanced settings may be include the ability to specify:
secondary data sources (5) (in the event of irrelevant results being generated by the primary data source (5));
associations with other Search Groups (20) to obtain re-ranked search results from, promoted websites and/or keywords, and other information associated with those Search Groups (20). This will enable new Search Groups to develop more rapidly with a wider membership contributing towards the search results re-ranking;
adult content filtering;
specifying the number of paid/sponsored URL links (4) appearing with the search results listing (8); and
the type of Search Group governance.

The Search Group governance may be solely controlled by the creator or moderator (23) with users only able to access results without providing any input. Alternatively, a moderator (23) may be able to partially override some of the Search Group members' contribution, veto the influence of certain keywords (7) or data sources (5), or the like. Search Groups (20) may also be configured with no overt control in a form of anarchy in which any user can submit/promote websites, keywords, and so forth.

FIG. 4 shows a web page of a user who is a member of a search group (20) for “Horse Racing” represented by tab (28) at the top of the screen. Other selectable tabs for “Web” (29), “Blog” (30) and “News” (31) relate to different feeds (i.e. data sources (5)) to provide the search results. The “History” (32) tab restricts the user to search queries (6) and websites (4) previously accessed by the user. The “My Search” tab (33) is the default search setting, and produces a search results listing (8) from a combination of filtered portions (11) from all the users search groups (20). The screen also shows an example of a pair of suggestions listings in the form of “What's Hot” lists (34, 35) of search queries (6) and URL links to websites (4) respectively, that are either the most popular and/or are rising in popularity the most rapidly amongst all the users of the search engine (1). Such suggestions listings may also be filtered by the user's search chosen groups/data sources (29, 30, 31). The “What's Hot” search queries list (34) also shows individual search queries (6) with various supplementary information, including that the search was “recent” (36), popular (37), or giving an email hot-link (38) to contact the user performing the search and the elapsed duration since the search (39).

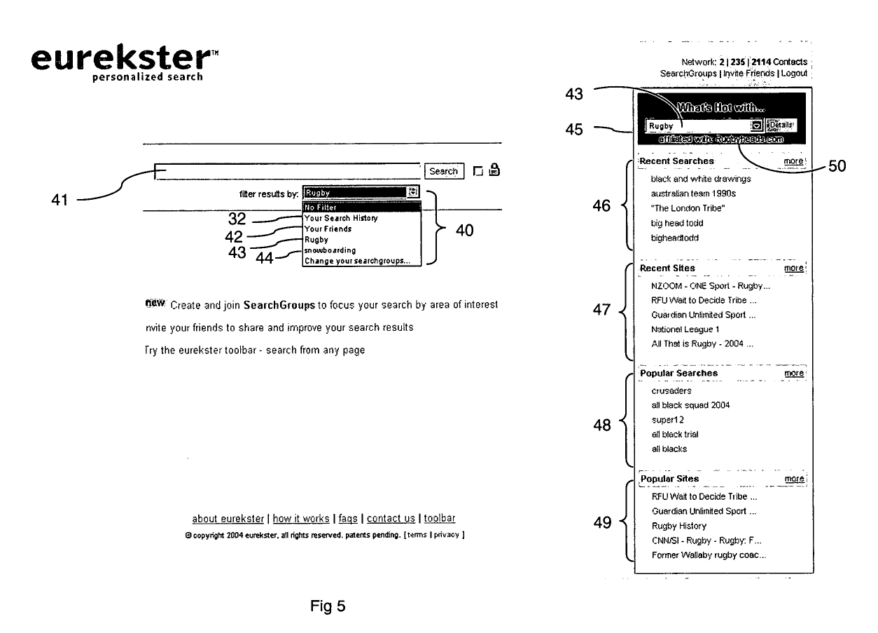

FIG. 5 shows an alternative screen configuration to that of FIG. 4, in which a drop-down menu (40) adjacent the search input window (41) enables the user to filter the results according to different settings, including any search groups (20) linked to the user, or the user's previous search history (32), or the results of the user's “friends” (42). The “friends” (42) may be individuals specifically invited by the user to pool search results. This is in effect a search group (20) in all but name, whose common link is the friendship/acquaintanceship between the members. Alternatively, the “friends” (42) may be derived from the user's contacts in a personal private contact network (12).

The embodiment in FIG. 5 shows the user having membership of “snowboarding” and “Rugby” search groups (43, 44). The “what's hot” listing (45) gives separate ranked listings for recent searches (46), recent sites (47), popular searches (48) and popular sites (49). All the “What's hot” Listings (45) may be filtered according to categories of the search filter drop-down menu (40), with the FIG. 5 showing filtering by the “rugby” search group (43). Also listed is a link to a website (50) “affiliated” to the search group, i.e. actively promoted by its members through user submissions.

Aspects of the present invention have been described by way of example only, and it should be appreciated that modifications and additions may be made thereto without departing from the scope thereof.

What is claimed:

1. An adaptive search engine having a plurality of data items from one or more data sources stored in at least one database searchable by a search query of at least one keyword to produce a corresponding ranked search result listing of data items, said search engine having a plurality of selectable filters applicable by the search engine and/or the user to filter at least a portion of the data items of the search result listing,
characterised in that
said search engine records an association between a filter applied to a search query and a data item selected by a user from said filtered portion of the corresponding search result listing, wherein each recorded association contributes to the weighting given by the search engine to application of said filter in a subsequent search for at least one keyword of said search query.

2. An adaptive search engine as claimed in claim 1, wherein said filters include at least one of: one or more said data sources; Keyword filters; user submissions—including user comments, answers to questions, chat-room threads, blog inputs and the like, news, picture); search groups; human editorial control/moderator; user-behaviour analysis; Keyword suggestions; Website filter; Domain filters; Link analysis filters; Category filters; Class of query (ranked according to whether or not the search query had been performed previously and if so, on search success); Advanced rule-based learning adaptations of other filters; Data item creation or update date; User's geographic location; Language; File format, frequency of spidering web-pages; and/or Mature Content filter.

3. An adaptive search engine as claimed in claim 1, configured such that said search engine classifies selection of a data item as being relevant when the user performs at least one action in association with the selected data item to meet at least one predetermined relevancy criteria.

4. An adaptive search engine as claimed in claim 1, configured such that the search engine reduces the ranking of a selected data item when the user does not perform at least one action in association with the selected data item to meet at least one predetermined relevancy criteria, said selected data item being classified as irrelevant.

5. An adaptive search engine as claimed in claim 4, configured such that said predetermined relevancy criteria includes at least one of:
whether the user accesses a data item for longer than a predetermined period,
accessing further data items directly from the first selected data item, submitting, and/or
downloading data to/from the data item.

6. An adaptive search engine as claimed in claim 1, configured such that an increase or decrease by the search engine in said weighting of the application of a filter includes a commensurate increase or decrease in:
the proportional volume of said filtered portion results; and/or
the ranking of the filtered portion results; and/or
the number and/or ranking of results obtained from a given data source.

7. An adaptive search engine as claimed in claim 1, wherein said data sources include websites, domain names and categories, personal contact networks, news groups, search groups, third-party search engines including category-specific search engines, geographical regions, blog sites, intranets, LAN and WAN networks, and/or any other form of searchable source of data.

8. An adaptive search engine as claimed in claim 2, wherein said search groups are a category-specific group of users weighting their search results listings from the effects of their combined search results, search result ranking, filters, and/or data sources derived from the search group members.

9. An adaptive search engine as claimed in claim 8, configured such that said category is user-definable.

10. An adaptive search engine as claimed in claim 2, configured such that a search group is capable of displaying to its members one or more suggestions listings compiled from searches or sites obtained from the direct or indirect recommendations of the group members, said suggestions listings including;
recent searches denoting the most recent keywords or search result listings associated with the keywords used by the user contacts;
popular websites denoting a ranking of websites most regularly visited by, and/or recommended by the user contacts;
popular searches denoting a ranking of the most popular keywords or search results associated with the keywords used by the user contacts;
high-flying searches denoting a list of keywords or search result listings associated with the keywords ranked according to their rate of increase in the popular searches ranking; and
high-flying websites denoting a list of websites ranked according to their rate of increase in the popular websites ranking.

11. An adaptive search engine as claimed in claim 8, wherein a user may utilize, or become a member of, a search group for a given category by at least one of:
actively selecting said search group;
selecting an external data source from a corresponding category-specific third-party search engine or website;
accessing a search box from a corresponding category-specific website; and
selecting a link from the results listings to the same search query performed by a specified search group.

12. An adaptive search engine as claimed in claim 11, configured such that a user accessing a search box from a category specific website for a predetermined threshold number of occurrences is automatically made a member of a search group corresponding to said category.

13. An adaptive search engine as claimed in claim 1, configured such that a user selecting a predetermined threshold number results from a search results listing which would have an altered ranking in searches for the same keywords performed by a given search group is automatically made a member of said given search group.

14. An adaptive search engine as claimed in claim 2, configured such that for a user performing a search query without actively specifying any filter, said search engine checks the search query keywords against at least some of the search groups linked with the user for any re-ranked results for said search query for incorporation in the search results listing.

15. An adaptive search engine as claimed in claim 2, configured such that the initial or default filters are selectable by the user, or by a search group or search engine moderator, and/or inferred from settings specified external to the search engine.

16. An adaptive search engine as claimed in claim 2, configured such that a user's search history is comparable with other users to identify corresponding search history or patterns.

17. An adaptive search engine as claimed in claim 16, configured such that identification of corresponding patterns of search activities generates a membership or offer of membership to the user for search groups associated with users with said corresponding search activities.

18. An adaptive search engine as claimed in claim 1, configured such that initial filters applied by the search engine are selected according to one or more context indicators.

19. An adaptive search engine as claimed in claim 1, configured such that initial selection of said filter is either user-selected or calculated from one or more predetermined relationships incorporating at least one context indicator related to characteristics of the user, the filter, and/or both.

20. An adaptive search engine as claimed in claim 1, wherein context indicators include at least one of any definable and recordable facet or characteristic of a filter selected by a user and/or a user's interests, contact details, personal or bibliographic details, personal contacts network, previous search history, web-surfing history, cookie information, occupation, membership or use of search groups, information shared as part of trusted private personal networks, geographical location, language, domain name type, and data voluntarily inputted by the user into the search engine.

21. An adaptive search engine as claimed in claim 1, wherein the context indicators are at least partially determined by recording information relating to:
the user,
the search query,
any filters applied to refine the search; and/or
the effects of the filters on the quality of the subsequent results.

22. An adaptive search engine as claimed in claim 8, wherein search groups are configurable as either public or private, whereby temporary utilisation of, or membership of said search groups is either open to any user or by invitation from existing search group members respectively.

23. An adaptive search engine as claimed in claim 22, wherein a search group is configurable such that the search results may be influenced by, and/or, filters may be modified by:
any search group member,
by a search group moderator, or
any member with consensus from other search group members.

24. An adaptive search engine as claimed in claim 1, configured such that derived filters are obtainable from any property or characteristic in addition to the search query keywords common to two or more data items in the search results listings.

25. An adaptive search engine as claimed in claim 2, configured such that a listing of preferred data sources for a search group is complied from data sources contributing search results accessed by the search group users more than a predetermined threshold number of occurrences, and a listing of “irrelevant” data sources for a search group is complied from data sources contributing search results accessed by users less than a predetermined threshold number of occurrences.

26. An adaptive search engine as claimed in claim 25, configured such that said preferred data sources listing and/or irrelevant data source listing are displayable to search group members.

27. An adaptive search engine as claimed in claim 25, configured such that said preferred data sources increase the weighting given by the search engine to application of said preferred data sources as a derived filter in subsequent searches by the search group.

28. An adaptive search engine as claimed in claim 26, configured such that said irrelevant data sources decreases the weighting given by the search engine to application of said irrelevant data sources as a derived filter in subsequent searches by the search group.

29. An adaptive search engine as claimed in claim 25, configured such that said derived filters are only obtainable from relevant data items selected by the user.

30. An adaptive search engine as claimed in claim 25, configured such that the list of preferred data sources for a given search query is supplementable by data sources providing relevant selections for said given search query performed for other search groups and/or non-search group general searches.

31. An adaptive search engine as claimed in claim 30, configured such that said supplemented data sources are displayed to the user as suggestions listings, and/or used to contribute at least a proportion of the search result listing to said given search group.

32. An adaptive search engine as claimed in claim 1, configured such that said filters are at least partially determined by one or more context indicator(s) associated with the search query, the user, and/or the results.

33. An adaptive search engine as claimed in claim 1, configured such that said search result listing is ranked by one of more filters applied by the search engine, one or more search groups and/or the user.

34. An adaptive search engine as claimed in claim 1, configured such that users can promote at least one of: data items, data sources, and/or filters by submission to the search engine.

35. An adaptive search engine as claimed in claim 34, configured such that said submission is visible to all the users or only to members of specific search groups.

36. An adaptive search engine as claimed in claim 2, configured such that the search results and associated results re-rankings of two or more search groups may be combined.

37. An adaptive search engine as claimed in claim 1, configured such that an interface with the search engine is spontaneously generated on the user's display screen according to a trigger related to at least one of: an occurrence of a predetermined context indicator, a user's surfing activity during the current session, and the domain name currently accessed by the user.

38. An adaptive search engine as claimed in claim 1, configured such that said search engine is accessible by a downloadable desktop application programme for installation on a client-side data input device provided by the search engine or an affiliated partner of the search engine.

39. An adaptive search engine as claimed in claim 38, configured such that said desktop application is capable of operating concurrently while the user is accessing an internet-linked document or email.

40. An adaptive search engine as claimed in claim 1, including:
at least one host computer processor connectable to one or more network(s),
a database accessible over said network(s), and
a plurality of data input devices connectable to said network(s).

41. A method of performing searches using an adaptive search engine having a plurality of data items from one or more data sources stored in at least one database searchable by a search query of a least one keyword to produce a corresponding ranked search result listing of data items, said search engine having a plurality of selectable filters applicable by the search engine and/or the user to filter at least a portion of the data items of the search result listing,
characterised in that
said search engine records an association between a filter applied to a search query and a data item selected by a user from said filtered portion of the corresponding search result listing, wherein each recorded association contributes to the weighting given by the search engine to application of said filter in a subsequent search for at least one keyword of said search query.

42. A method as claimed in claim 41, wherein said filters include, but are not limited to: one or more said data sources; Keyword filters; user submissions—including user comments, answers to questions, chat-room threads, blog inputs and the like, news, picture); search groups; human editorial control/moderator; user-behaviour analysis; Keyword suggestions; Website filter; Domain filters; Link analysis filters; Category filters; Class of query (ranked according to whether or not the search query had been performed previously and if so, on search success); Advanced rule-based learning adaptations of other filters; Data item creation or update date; User's geographic location; Language; File format, frequency of spidering web-pages; and/or Mature Content filter.

43. A method as claimed in claim 41, wherein said search engine classifies a selection of a data item as being relevant when the user performs at least one action in association with the selected data item to meet at least one predetermined relevancy criteria.

44. A method as claimed in claim 41, wherein the search engine reduces the ranking of a selected data item when the user does not perform at least one action in association with the selected data item to meet at least one predetermined relevancy criteria, said selected data item being classified as irrelevant.

45. A method as claimed in claim 44, wherein said predetermined relevancy criteria includes at least one of:
whether the user accesses a data item for longer than a predetermined period,
accessing further data items directly from the first selected data item, submitting, and/or
downloading data to/from the data item.

46. A method as claimed in claim 41, wherein an increase or decrease in said weighting of the application of a filter includes a commensurate increase or decrease in:
the proportional volume of said filtered portion results; and/or
the ranking of the filtered portion results; and/or
the number and/or ranking of results obtained from a given data source.

47. A method as claimed in claim 41, wherein said data sources includes websites, domain names and categories, personal contact networks, news groups, search groups, third party search engines including category-specific search engines, geographical regions, blog sites, intranets, LAN and WAN networks, and/or any other form of searchable source of data.

48. A method as claimed in claim 42, wherein said search groups are a category-specific group of users combining input from cumulative search results, search result ranking, filters, and/or data sources of other search group members.

49. A method as claimed in claim 48, wherein said category is user-definable.

50. A method as claimed in claim 42, wherein a search group displays to its members one or more suggestions listings searches or sites obtained from the direct or indirect recommendations of the group members, said suggestions listings including at least one of:
recent searches denoting the most recent keywords or search result listings associated with the keywords used by the user contacts;
popular websites denoting a ranking of websites most regularly visited by, and/or recommended by the user contacts;
popular searches denoting a ranking of the most popular keywords or search results associated with the keywords used by the user contacts;
high-flying searches denoting a list of keywords or search result listings associated with the keywords ranked according to their rate of increase in the popular searches ranking; and
high-flying websites denoting a list of websites ranked according to their rate of increase in the popular websites ranking.

51. A method as claimed in claim 42, wherein a user may utilize, or become a member of, a search group for a given category by at least one of:
actively selecting said search group;
selecting an external data source from a corresponding category-specific third-party search engine or website;
accessing a search box from a corresponding category-specific website; and
selecting a link from the results listings to the same search query performed by a specified search group.

52. A method as claimed in claim 51, wherein a user accessing a search box from a category-specific website for a predetermined threshold number of occurrences is automatically made a member of a search group corresponding to said category.

53. A method as claimed in claim 41, wherein a user selecting a predetermined threshold number results from a search results listing which would have an altered ranking in searches for the same keywords performed by a given search group is automatically made a member of said given search group.

54. A method as claimed in claim 42, wherein for a user performing a search query without actively specifying any filter, said search engine checks the search query keywords against at least some of the search groups linked with the user for any re-ranked results for said search query for incorporation in the search results listing.

55. A method as claimed in claim 41, wherein the initial or default filters are selectable by the user, or by a search group or search engine moderator, and/or inferred from settings specified external to the search engine.

56. A method as claimed in claim 42, wherein a user's search history is compared with other users to identify corresponding search history or patterns.

57. A method as claimed in claim 56, wherein identification of corresponding patterns of search activities generates a membership or offer of membership to the user for search groups associated with users with said corresponding search activities.

58. A method as claimed in claim 41, wherein initial filters applied by the search engine are selected according to one or more context indicators.

59. A method as claimed in claim 41, wherein initial selection of said filter is either user-selected or calculated from one or more predetermined relationships incorporating at least one context indicator related to characteristics of the user, the filter or both.

60. A method as claimed in claim 41, wherein context indicators include at least one of any definable and recordable facet or characteristic of a filter selected by a user and/or a user's interests, contact details, personal or bibliographic details, personal contacts network, previous search history, web surfing history, cookie information, occupation, membership or use of search groups, information shared as part of trusted private personal networks, geographical location, language, domain name type, and data voluntarily inputted by the user into the search engine.

61. A method as claimed in claim 60, wherein the context indicators are at least partially determined by recording information relating to:
the user,
the search query,
any filters applied to refine the search; and/or
the effects of the filters on the quality of the subsequent results.

62. A method as claimed in claim 48, wherein search groups are configurable as either public or private, whereby temporary utilisation of, or membership of said search groups is either open to any user or by invitation from existing search group members respectively.

63. A method as claimed in claim 62, wherein a search group is configurable such that the search results may be influenced by, and/or, filters may be modified by:
any search group member,
by a search group moderator, or
any member with consensus from other search group members.

64. A method as claimed in claim 41, wherein derived filters are obtained from any property or characteristic in addition to the search query keywords common to two or more data items in the search results listings.

65. A method as claimed in claim 41, wherein a listing of preferred data sources for a search group is complied from data sources contributing search results accessed by the search group users more than a predetermined threshold number of occurrences, and a listing of “irrelevant” data sources for a search group is complied from data sources contributing search results accessed by users less than a predetermined threshold number of occurrences.

66. A method as claimed in claim 65, wherein said preferred data sources listing and/or irrelevant data source listing may be displayed to search group members.

67. A method as claimed in claim 65, wherein said preferred data sources increase the weighting given by the search engine to application of said preferred data sources as a derived filter in subsequent searches by the search group.

68. A method as claimed in claim 65, wherein said irrelevant data sources decrease the weighting given by the search engine to application of said irrelevant data sources as a derived filter in a subsequent searches by the search group.

69. A method as claimed in claim 64, wherein said derived filters are obtained from relevant data items selected by the user.

70. A method as claimed in claim 64, wherein the listing of preferred data sources for a given search query is supplemented by data sources providing relevant selections for said given search query performed for other search groups and/or non-search group general searches.

71. A method as claimed in claim 70, wherein said supplemented data sources are displayed to the user as suggestions listings, and/or used to contribute at least a proportion of the search result listing to said given search group.

72. A method as claimed in claim 41, wherein said filters are at least partially determined by one or more context indicator(s) associated with the search query, the user, or the results.

73. A method as claimed in claim 41, wherein said search result listing is ranked by one of more filters applied by the search engine.

74. A method as claimed in claim 41, wherein users can promote at least one of: data items, data sources, and/or filters by submission to the search engine.

75. A method as claimed in claim 74, wherein said submission is visible to all the users or only to members of specific search groups.

76. A method as claimed in claim 41, wherein the search results and associated results re-rankings of two or more search groups may be combined.

77. A method as claimed in claim 41, wherein an interface with the search engine is spontaneously generated on the user's display screen according to a trigger related to at least one of: an occurrence of a predetermined context indicator, a user's surfing activity during the current session, and the domain name currently accessed by the user.

78. A method as claimed in claim 41, wherein said search engine is accessible by a downloadable desktop application programme installed on a user-side site provided by the search engine or an affiliated partner of the search engine.

79. A method as claimed in claim 78, wherein said desktop application is capable of operating concurrently while the user is accessing an internet-linked document or email.
